(19) United States
(12) Patent Application Publication
(10) Pub. No.: US 2012/0134586 A1
(43) Pub. Date: May 31, 2012

(54) DEVICE WITH DATASTREAM PIPELINE ARCHITECTURE FOR RECOGNIZING AND LOCATING OBJECTS IN AN IMAGE BY DETECTION WINDOW SCANNING

(75) Inventors: Suresh Pajaniradja, Bourg-La-Reine (FR); Eva Dokladalova, Dammarie Les Lys (FR); Mickael Guibert, Le Perreux-Sur-Marne (FR); Michaël Zemb, Viroflay (FR)

(73) Assignee: Commissariat A L'Energie Atomique Et Aux Energies Alternative, Paris (FR)

(21) Appl. No.: 13/133,617

(22) PCT Filed: Nov. 23, 2009
(86) PCT No.: PCT/EP2009/065626

§ 371 Date: Nov. 18, 2011

(30) Foreign Application Priority Data
Dec. 9, 2008 (FR) 08/06905

(51) Int. Cl. G06K 9/62

(52) U.S. Cl. 382/170

(57) ABSTRACT

A device for recognizing and locating objects in an image by scanning detection windows comprises a data stream architecture designed in pipeline form for concurrent hardware tasks and includes means for generating a descriptor for each detection window, a histogram determination unit determining a histogram of orientation gradients for each descriptor, and N processing units in parallel, capable of analyzing the histograms as a function of parameters associated with the descriptors to provide a partial score representing the probability that the descriptor concerned contains at least part of the object to be recognized, the sum of the partial scores of each detection window providing a global score representing the probability that the detection window contains the object to be recognized.

The invention relates to a device for recognizing and locating objects in a digital image. It is applicable, notably, to the fields of on-board electronics requiring a detection and/or classification function, such as video surveillance, mobile video processing, and driving assistance systems.

Movement detection can be carried out by simple subtraction of successive images. However, this method has the drawback of being unable to discriminate between different types of moving objects. In particular, it is impossible to discriminate between the movement of foliage due to wind and the movement of a person. Furthermore, in on-board applications, the whole image can be subject to movement, for example as a result of the movement of the vehicle on which the camera is fixed.

The detection of a complex object such as a person or a human face is also very difficult because the apparent shape of the object depends not only on its morphology but also on its posture, the angle of view and the distance between the object and the camera. To these difficulties must be added the problems of variations in the illumination, exposure and occultation of objects.

P. Viola and M. Jones have developed a method for the reliable detection of an object in an image. This method is described, notably, in P. Viola and M. Jones, Robust Real-time Object Detection, 2^{nd} International Workshop on Statistical and Computational Theories of Vision—Modelling, Learning, Computing and Sampling, Vancouver, Canada, July 2001. It comprises a training phase and a recognition phase. In the recognition phase, the image is scanned with a detection window whose size is varied in order to identify objects of different sizes. The object identification is based on the use of single-variable descriptors such as Haar wavelets, which are relatively simple shape descriptors. These descriptors are determined in the training phase and can be used to test representative features of the object to be recognized. These features are commonly referred to as the signature of the object. For each position in the image, a detection window is analyzed by a plurality of descriptors in order to test features in different regions of the detection window and thus obtain a relatively reliable result.

Multivariable descriptors have been proposed with a view to improving the effectiveness of the descriptors. A multivariable descriptor is composed, for example, of a histogram of the orientation of the intensity gradients, together with a density component of the magnitude of the gradient.

In order to increase the speed of the detection method, the descriptors are grouped in classifiers which are tested subsequently in a staged cascade or loop. Each stage of the cascade executes more complex and selective tests than the preceding stage, thus rapidly eliminating irrelevant regions of the image such as the sky.

At the present time, the method of Viola and Jones is implemented in hardware form in fully dedicated circuits, or in software form in processors. The hardware implementation performs well but is highly inflexible. This is because a dedicated circuit is hardwired to detect a given type of object with a given accuracy. On the other hand, the software implementation is very flexible because of the presence of a program, but performance is often found to be poor because general-purpose processors have insufficient computing power and/or because digital signal processors (DSP) are very inefficient at handling conditional branching instructions. Moreover, it is difficult to integrate software solutions into an on-board system such as a vehicle or a mobile telephone, because they have very high power consumption and large overall dimensions. Finally, in most cases the internal storage and/or bandwidth are insufficient to allow rapid detection. The paper by Li Zhang and others, “Efficient Scan-Window Based Object Detection using GPGPU”, 2008, describes a first example of software implementation applied to the detection of pedestrians. This implementation is based on a General-Purpose computation on Graphics Processing Unit (GPGPU). The graphics processing unit has to be linked to a processor via a memory controller and a PCI Express bus. Consequently this implementation consumes a large amount of power, both for the graphics processing unit and the processor, of the order of 300 to 500 W in total, and it has an overall size of several tens of square centimeters, making it unsuitable for on-board solutions. The paper by Christian Wojek and others, “Sliding-Windows for Rapid Object Class Localization: A Parallel Technique”, 2008, describes a second example of software implementation, also based on a GPGPU. This example has the same drawbacks as regards on-board applications.

One object of the invention is, notably, to overcome some or all of the aforesaid drawbacks by providing a device dedicated to the recognition and location of objects, which is not programmable but can be parameterized to enable different objects to be detected with a variable degree of accuracy, notably as regards false alarms. For this purpose, the invention proposes a device for recognizing and locating objects in a digital image by scanning detection windows, characterized in that it comprises a data stream pipeline architecture for concurrent hardware tasks, the architecture including:
means for generating a descriptor for each detection window, each descriptor delimiting part of the digital image belonging to the detection window concerned,
a histogram identification unit which determines, for each descriptor, a histogram representing features of the part of the digital image delimited by the descriptor concerned,
N parallel processing units, a detection window being assigned to each processing unit, each processing unit being capable of analyzing the histogram of the descriptor concerned as a function of parameters associated with each descriptor, to provide a partial score representing the probability that the descriptor contains at least a part of the object to be recognized, the sum of the partial scores of each detection window providing a global score representing the probability that the detection window contains the object to be recognized.

The invention is advantageous, notably, in that it can be implemented as an application specific integrated circuit (ASIC), or as a field programmable gate array (FPGA). Consequently, the surface area and power consumption of the device according to the invention are only one hundredth of those of a programmed solution. Thus the device can be integrated into an on-board system. The device can also be used to execute a number of classification tests in parallel, thus providing high computing power. The device is fully parameterizable. The type of detection, the accuracy of detection and the number of descriptors and classifiers used can therefore be adjusted in order to optimize the ratio between the quality of the result and the calculation time.

Another advantage of the device is that it parallelizes the tasks by means of its pipeline architecture. All the modules operate concurrently (at the same time). In this case, if we consider a sequence of sets of given descriptors, the processing units analyze the histograms associated with the descriptors of rank p, the histogram determination unit determines the histograms associated with the descriptors of rank p+1, and the means for generating descriptors determine the descriptors of rank p+2, within a single time interval. Thus the time for determining the descriptors and the histograms is masked by the time allocated for detection, in other words the histogram analysis time. The device therefore has a high computing power.

The invention will be more fully explained and other advantages will be made clear by the detailed description of an embodiment provided by way of example, this description making reference to the attached drawings which show:

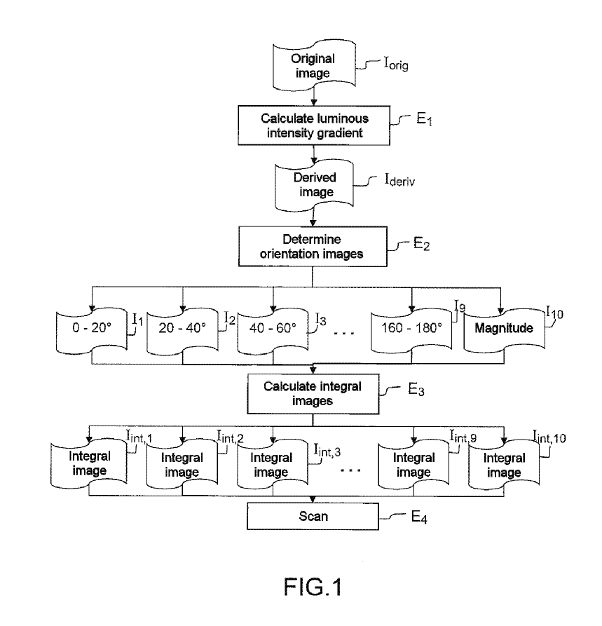

in FIG. 1, possible steps of the operation of a device according to the invention;

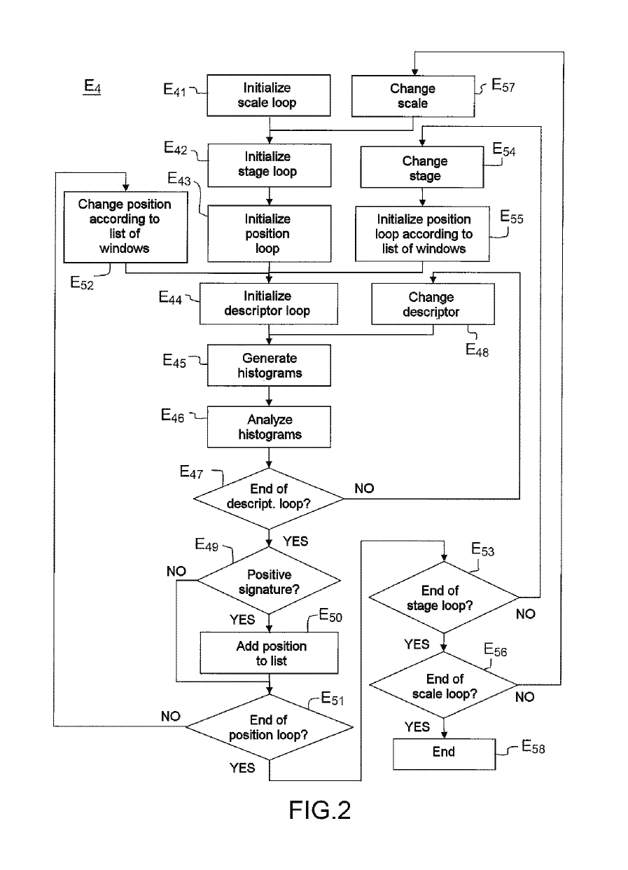

in FIG. 2, possible sub-steps of the operation of the device shown in FIG. 1;

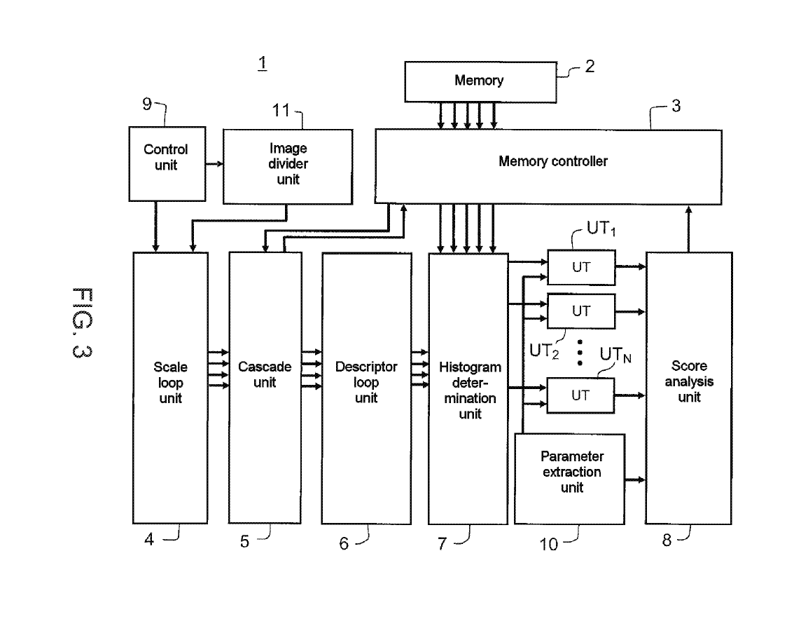

in FIG. 3, a synoptic diagram of an exemplary embodiment of a device according to the invention;

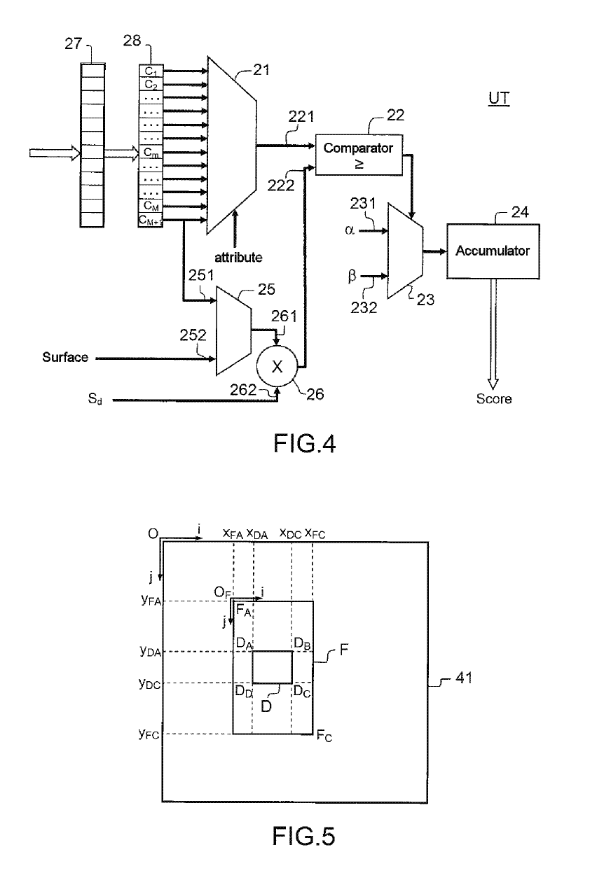

in FIG. 4, an exemplary embodiment of a processing unit of the device of FIG. 3;

in FIG. 5, an illustration of the different systems of coordinates used for the application of the invention;

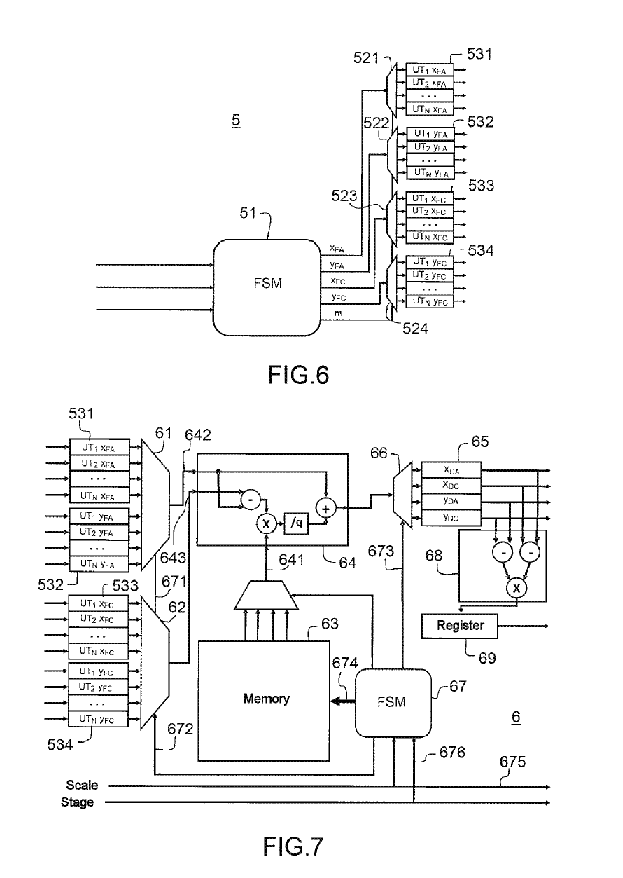

in FIG. 6, an exemplary embodiment of a cascade unit of the device of FIG. 3;

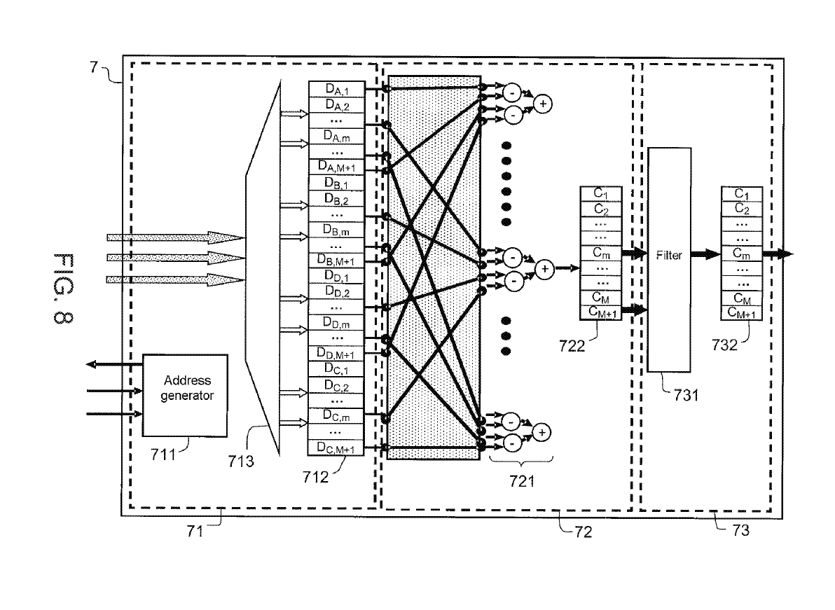

in FIG. 7, an embodiment of a descriptor loop unit of the device of FIG. 3;

in FIG. 8, an exemplary embodiment of a histogram determination unit of the device of FIG. 3;

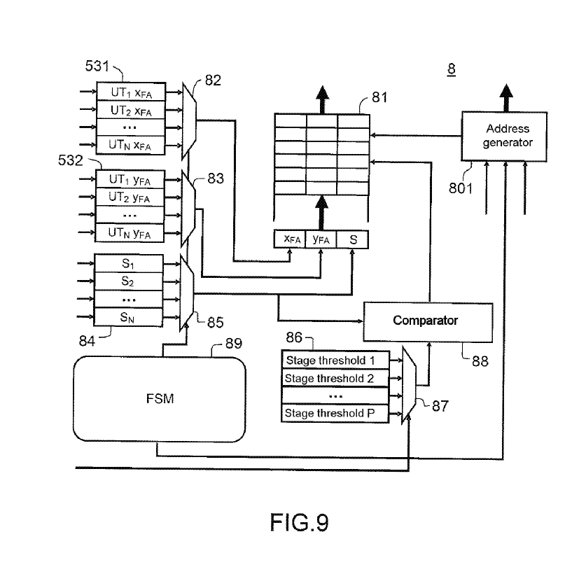

in FIG. 9, an exemplary embodiment of a score analysis unit of the device of FIG. 3.

FIG. 1 illustrates possible steps of the operation of a device according to the invention. The remainder of the description will refer to digital images formed by a matrix of Nc columns by Nl rows of pixels. Each pixel contains a value, called a weight, representing the amplitude of a signal, for example a weight representing a luminous intensity. The operation of a device according to the invention is based on a method adapted from the method of Viola and Jones. This method is described, for example, in patent application WO2008/104453 A. This detection method is based on calculations of double precision floating point numbers. These calculations require complex floating point arithmetic units which are costly in terms of execution speed, silicon surface area and power consumption. The method has been modified to use operations on fixed point data. These operations require only integer operators which are simpler and faster. The method has also been modified to avoid the use of division operations in the calculation of the detection of the processing units. Thus, by using integer operations only (addition and multiplication), the calculations are faster, the device is smaller and its power consumption is reduced. However, fixed point calculations are less accurate and the method has had to be modified to allow for this error in the calculations.

In a first step E₁, the amplitude gradient signature of the signal is calculated for the image, called the original image I_{orig}, in which objects are searched for. This signature is, for example, that of the gradient of luminous intensity. It generates a new image, called the derived image, I_{deriv}. From this derived image I_{deriv}, M orientation images Iₘ, where m is an index varying from 1 to M, can be calculated in a second step E₂, each orientation image Iₘ having the same size as the original image I_{orig} and containing, for each pixel, the luminous intensity gradient over a certain range of angle values. For example, 9 orientation images Iₘ can be obtained for 20° ranges of angle values. The first orientation image I₁ contains, for example, the luminous intensity gradients having a direction in the range from 0° to 20°, the second orientation image I₂ contains the luminous intensity gradients having a direction in the range from 20° to 40°, and so on up to the ninth orientation image I₉ containing the luminous intensity gradients having a direction in the range from 160° to 180°. An M+1th, that is to say a tenth, orientation image I_{M+1} corresponding to the magnitude of the luminous intensity gradient can also be determined, where M is equal to 9 in the example of FIG. 1. This M+1th orientation image I_{M+1} can be used, notably, to provide information on the presence of contours. In a third step E₃, each orientation image Iₘ is converted into an integral image I_{int,m}, where m varies from 1 to M. An integral image is an image having the same size as the original image, where the weight wi(m,n) of each pixel p(m,n) is determined by the sum of the weights wo(x,y) of all the pixels p(x,y) located in the rectangular surface delimited by the origin O of the image and the pixel p(m,n) in question. In other words, the weight wi(m,n) of the pixels p(m,n) of an integral image I_{int,m} can be modeled by the relation:

$$∀ ( m , n ) ∈ [ 1 , N 1 ] \times [ 1 , Nc ] , wi ( m , n ) = {\sum }_{x = 1}^{m} {\sum }_{y = 1}^{n} wo ( x , y ) \qquad ( 1 )$$

In a fourth step E₄, the M+1 integral images I_{int,m} obtained in this way are scanned by detection windows of different sizes, each comprising one or more descriptors. The M+1 integral images I_{int,m} are scanned simultaneously in such a way that the scanning of these integral images I_{int,m} corresponds to a scanning of the original image I_{orig}. A descriptor delimits part of an image belonging to the detection window. The signature of the object is searched for in these image parts. The scanning of the integral images I_{int,m} by the windows is carried out by four levels of nested loops. A first loop, called the scale loop, loops on the size of the detection windows. The size decreases, for example, as progress continues in the scale loop, so that smaller and smaller regions are analyzed. A second loop, called the stage loop, loops on the level of complexity of the analysis. The level of complexity, also called the stage, depends mainly on the number of descriptors used for a detection window. For the first stage, the number of descriptors is relatively limited. There may be, for example, one or two descriptors per detection window. The number of descriptors generally increases with the stages. The set of descriptors used for a stage is called a classifier. A third loop, called the position loop, carries out the actual scanning; in other words, it loops on the position of the detection windows in the integral images I_{int,m}. A fourth loop, called the descriptor loop, loops on the descriptors used for the current stage. On each iteration of this loop, one of the descriptors of the classifier is analyzed to determine whether it contains part of the signature of the object to be recognized.

FIG. 2 is a more detailed illustration of the four levels of nested loops for the possible sub-steps for the fourth step E₄ of FIG. 1. In a first step E₄₁, the scale loop is initialized. The initialization of the scale loop includes, for example, the generation of an initial size of a detection window and of an initial movement step. In a second step E₄₂, the stage loop is initialized. The initialization of this loop comprises, for example, the determination of the descriptors used for the first stage. These descriptors can be determined by their relative coordinates in the detection window. In a third step E₄₃, the position loop is initialized. This initialization comprises, for example, the generation of the detection windows and the allocation of each detection window to a processing unit of the device according to the invention. The detection windows can be generated in the form of a list, called the list of windows. A different list is associated with each iteration of the scale loop. For the first iteration of the stage loop, the detection windows are usually generated in an exhaustive way, in other words in such a way that all the regions of the integral images I_{int,m} are covered.

A plurality of iterations of the position loop is required when the number of detection windows exceeds the number of processing units. The detection windows can be determined by their position in the integral images I_{int,m}. These positions are then stored in the list of windows. In a fourth step E₄₄, the descriptor loop is initialized. This initialization comprises, for example, the determination, for each detection window assigned to a processing unit, of the absolute coordinates of a first descriptor among the descriptors of the classifier associated with the stage in question. In a fifth step E₄₅, a histogram is generated for each descriptor. A histogram includes, for example, M+1 components Cₘ, where m varies from 1 to M+1. Each component Cₘ contains the sum of the weights wo(x,y) of the pixels p(x,y) of one of the orientation images Iₘ contained in the descriptor in question. The sum of these weights wo(x,y) can be found, notably, in a simple way by taking the weights of four pixels of the corresponding integral image, as described below. In a sixth step E₄₆, the histograms are analyzed. The result of each analysis is provided in the form of a score, called the partial score, representing the probability that the descriptor associated with the analyzed histogram contains part of the signature of the object to be recognized. In a seventh step E₄₇, the process determines whether the descriptor loop has terminated, in other words whether all the descriptors have been generated for the current stage. If this is not the case, the process continues in the descriptor loop to a step E₄₈ and loops back to step E₄₅. The forward movement in the descriptor loop comprises the determination, for each detection window allocated to a processing unit of the device, of the absolute coordinates of another descriptor among the descriptors of the classifier associated with the stage in question. A new histogram is then generated for each new descriptor and provides a new partial score. The partial scores are added together on each iteration of the descriptor loop in order to provide a global score S for the classifier for each detection window on the final iteration.

These global scores S then represent the probability that the detection windows contain the object to be recognized, this probability relating to the current stage. If it is found in step E₄₇ that the descriptor loop is terminated, a test is made in a step E₄₉ to determine whether the global scores S are greater than a predetermined stage threshold Sₑ. This stage threshold Sₑ is, for example, determined in a training phase. In a step E₅₀, the detection windows for which the global scores S are greater than the stage threshold Sₑ are stored in a new list of windows so that they can be analyzed again by the next stage classifier. The other detection windows are finally considered not to contain the object to be recognized. Consequently they are not stored and are not analyzed further in the rest of the process. In a step E₅₁, the process determines whether the position loop is terminated, in other words whether all the detection windows for the scale and stage in question have been allocated to a processing unit. If this is not the case, the process continues in the descriptor loop to a step E₅₂ and loops back to step E₄₄. The forward movement in the position loop comprises the allocation to the processing units of the detection windows which are included in the list of windows of the current stage but which have not yet been analyzed.

However, if the position loop is terminated, the process determines in a step E₅₃ whether the stage loop is terminated, in other words whether the current stage is the final stage of the loop. The current stage is, for example, marked by a stage counter. If the stage loop is not terminated, the stage is changed in a step E₅₄. The change of stage takes the form of incrementing the stage counter, for example. It can also include the determination of the relative coordinates of the descriptors used for the current stage. In a step E₅₅, the position loop is initialized as a function of the list of windows generated in the preceding stage. Detection windows on this list are then allocated to the processing units of the device. At the end of step E₅₅, the process loops back to step E₄₄. As in the first iteration of the stage loop, the steps E₅₁ and E₅₂ permit a loopback if necessary to ensure that each detection window to be analyzed is finally allocated to a processing unit. If it is found at step E₅₃ that the stage loop has been terminated, the process determines in a step E₅₆ whether the scale loop has been terminated. If this is not the case, the scale is changed in a step E₅₇ and loops back to step E₄₂. The change of scale comprises, for example, the determination of a new size of detection windows and a new movement step for these windows. The objects are then searched for in these new detection windows by using the stage, position and descriptor loops. If the scale loop has been terminated, in other words if all the sizes of the detection windows have been analyzed, the process is ended in a step E₅₈. The detection windows that have passed all the stages successfully, in other words those stored in the various lists of windows in the final iterations of the stage loop, are considered to contain the objects to be recognized.

FIG. 3 shows an exemplary embodiment of a device 1 according to the invention which executes the scanning step E₄ described above with reference to FIG. 2. The device 1 is implemented, for example, in the form of a small application-specific integrated circuit (ASIC). This circuit is advantageously parameterizable. Thus the device 1 is dedicated to an object recognition and location application, but some parameters can be modified in order to detect different types of objects. The device 1 comprises a memory 2 containing M+1 integral images I_{int,m}. The M+1 integral images I_{int,m} correspond to the integral images of M orientation images and to an integral image of the magnitude of the luminous intensity gradient, as defined above. The device 1 also comprises a memory controller 3, a scale loop unit 4, a cascade unit 5, a descriptor loop unit 6, a histogram determination unit 7, N processing units UT₁, UT₂, . . . , UT_{N} in parallel, generically denoted UT, a score analysis unit 8 and a control unit 9. The memory controller 3 can be used to control the access of the histogram determination unit 7 to the memory 2. The scale loop unit 4 is controlled by the control unit 9. It executes the scale loop described above. In other words, it generates the initialization of the scale loop in step E₄₁, while in step E₅₇ it generates a detection window size and a detection window movement step in the integral images I_{int,m}.

The size of the detection windows and the movement step can be parameterized. The scale loop unit 4 sends the detection window size data and movement step to the cascade unit 5. This unit 5 executes the stage and position loops. In particular, it generates coordinates (x_{FA},y_{FA}) and (x_{FC},y_{FC}) for each detection window as a function of the size of the windows and the movement step. These coordinates (x_{FA},y_{FA}) and (x_{FC},y_{FC}) are sent to the descriptor loop unit 6. The cascade unit 5 also allocates each detection window to a processing unit UT. The descriptor loop unit 6 executes the descriptor loop. In particular, it successively generates the coordinates (x_{DA},y_{DA}) and (x_{DC},y_{DC}) of the different descriptors of the classifier associated with the current stage, for each detection window allocated to a processing unit UT. These coordinates (x_{DA},y_{DA}) and (x_{DC},y_{DC}) are sent progressively to the histogram determination unit 7. The unit 7 successively determines a histogram for each descriptor from the coordinates (x_{DA},y_{DA}) and (x_{DC},y_{DC}) and the M+1 integral images I_{int,m}. In one embodiment, each histogram includes M+1 components Cₘ, each component Cₘ containing the sum of the weights wo(x,y) of the pixels p(x,y) of one of the orientation images Iₘ contained in the descriptor in question. The histograms are sent to the processing units UT₁, UT₂, . . . , UT_{N}. According to the invention, the N processing units UT₁, UT₂, . . . , UT_{N} are in parallel. Each processing unit UT executes an analysis on the histogram of one of the descriptors contained in the detection window allocated to it. A histogram analysis is executed, for example, as a function of four parameters, called “attribute”, “descriptor threshold S_{d}”, “α” and “β”. These parameters can be modified. They depend, notably, on the type of object to be recognized and the stage in question. They are, for example, determined in a training stage. Since the parameters are dependent on the stage iteration, they are sent to the processing units UT₁, UT₂, . . . , UT_{N} on each iteration of the stage loop in steps E₄₂ and E₅₄. A histogram analysis generates a partial score for this histogram, together with a global score for the classifier of the detection window allocated to it. The processing units UT can be used to execute up to N histogram analyses simultaneously. However, not all the processing units UT are necessarily used in an iteration of the descriptor loop. The number of processing units UT used depends on the number of histograms to be analyzed and therefore on the number of detection windows contained in the list of windows for the current stage. Thus the power consumption of the device 1 can be optimized as a function of the number of processes to be executed. At the end of the descriptor loop, the partial scores of the histograms are added together to give a global score S for the classifier of each detection window. These global scores S are sent to a score analysis unit 8. On the basis of these global scores S, the unit 8 generates the list of windows for the next stage of the stage loop.

The above description of the device 1 is provided with reference to that of the process of FIG. 2. However, it should be noted that the device 1 is based on a pipeline architecture. Thus the different steps of the process are executed in parallel for different descriptors. In other words, the different modules making up the device 1 operate simultaneously. In particular, the descriptor loop unit 6, the histogram determination unit 7, the N processing units UT₁, UT₂, . . . , UT_{N}, and the score analysis unit 8 form a first, a second, a third and a fourth stage, respectively, of the pipeline architecture.

FIG. 4 shows an exemplary embodiment of a processing unit UT for analyzing a histogram with M+1 components Cₘ. The processing unit UT comprises a first logic unit 21 including M+1 inputs and an output. The term “logic unit” denotes a controlled circuit having one or more inputs and one or more outputs, each output being connectable to one of the inputs according to a command applied to the logic unit, for example by a general controller or by an internal logic in the logic unit. The term “logic unit” is to be interpreted in the widest sense. A logic unit having a plurality of inputs and/or outputs can be formed by a set of multiplexers and/or demultiplexers and logic gates, each having one or more inputs and one or more outputs. The logic unit 21 can be used to select one of the M+1 components Cₘ as a function of the attribute parameter. The processing unit UT also comprises a comparator 22 having a first input 221 which receives the component Cₘ selected by the logic unit 21 and a second input 222 which receives the descriptor threshold parameter S_{d}. The result of the comparison between the selected component Cₘ and the threshold parameter S_{d} is sent to a second logic unit 23 including two inputs and one output. The first input 231 of this logic unit 23 receives the parameter α and the second input 232 receives the parameter β. Depending on the result of the comparison, the output of the logic unit 23 delivers either the parameter α or the parameter β. In particular, if the component Cₘ selected by the logic unit 21 is greater than the threshold parameter S_{d}, the parameter α is delivered at the output. Conversely, if the selected component Cₘ is lower than the threshold parameter S_{d}, the parameter β is delivered at the output. The output of the logic unit 23 is added to the value contained in an accumulator 24. If a plurality of components Cₘ of a histogram has to be compared, the logic unit 21 selects them in succession. The selected components Cₘ are then compared one by one with the threshold parameter S_{d}, and the parameters α and/or β are added together in the accumulator 24 in order to produce a partial score for the histogram. A processing unit UT then analyzes the different histograms of the descriptors forming a classifier. The parameters α and/or β can therefore be added together in the accumulator 24 for all the descriptors of the classifier in question, in order to obtain the global score S for this classifier in the detection window.

In one specific embodiment, the first M components Cₘ are divided by the M+1th component C_{M+1} before being compared with the threshold parameter S_{d}, while the M+1th component C_{M+1} is divided by the surface of the descriptor in question before being compared with the threshold parameter S_{d}. Alternatively, the threshold parameter S_{d} can be multiplied either by the M+1th component C_{M+1} of the analyzed histogram or by the surface of the descriptor according to the component Cₘ in question, as shown in FIG. 4. In this case, the processing unit UT also comprises a third logic unit 25 having a first input 251 receiving the M+1th component C_{M+1} of the histogram and a second input 252 receiving the surface of the descriptor. An output of the logic unit 25 connects one of the two inputs 251 and 252 to a first input 261 of a multiplier 26, depending on the multiplication chosen. A second input 262 of the multiplier 26 receives the threshold parameter S_{d}, and an output of the multiplier 26 is then connected to the second input 222 of the comparator 22.

A processing unit UT can also include two buffer memories 27 and 28 in series. The first buffer memory 27 can receive from the histogram determination unit 7 the M+1 components Cₘ of a first histogram at a given time interval. In the next time interval, the components Cₘ of the first histogram can be transferred to the second buffer memory 28, this memory being connected to the inputs of the logic unit 21, while the components Cₘ of a second histogram can be loaded into the first buffer memory 27. By using two buffer memories, it is possible to compensate for the histogram calculation time.

FIG. 5 shows the different coordinate systems used for the present invention. A Cartesian reference frame (O,i,j) is associated with an image 41, which in this case is an integral image I_{int,m}. The origin O is, for example, fixed at the upper left-hand corner of the image 41. A detection window F can thus be identified in this image 41 by the coordinates (x_{FA},y_{FA}) and (x_{FC},y_{FC}) of two of its opposite corners F_{A} and F_{C}. A second Cartesian reference frame (O_{F},i,j) can be associated with the detection window F. The origin O_{F} is, for example, fixed at the upper left-hand corner of the detection window F. The position of a descriptor D is determined by two of its opposite corners D_{A} et D_{C}, in the reference frame (O_{F},i,j), using the relative coordinates (x′_{DA},y′_{DA}) and (x′_{DC},y′_{DC}), and also in the reference frame (O,i,j), using the absolute coordinates (x_{DA},y_{DA}) and (x_{DC},y_{DC}).

FIG. 6 shows an exemplary embodiment of a cascade unit 5. The unit 5 comprises a finite state machine 51, four logic units 521, 522, 523 and 524 each comprising an input and N outputs, and four register blocks 531, 532, 533 and 534, each register block being associated with a logic unit 521, 522, 523 or 524. A register block 531, 532, 533 or 534 includes N data registers, each data register being connected to one of the outputs of the associated logic unit 521, 522, 523 or 524. The finite state machine 51 receives the information on the detection window size and movement step, and generates up to N detection windows F which it allocates to the processing units UT₁, UT₂, . . . , UT_{N}. The generation of the detection windows comprises the determination of the coordinates (x_{FA},y_{FA}) and (x_{FC},y_{FC}) of their corners F_{A} and F_{C}. As mentioned above, the coordinates (x_{FA},y_{FA}) and (x_{FC},y_{FC}) of the detection windows F are exhaustively generated in the first iteration of the stage loop. For the next iterations, only the detection windows F included in the list of positions are analyzed. The coordinates (x_{FA},y_{FA}) and (x_{FC},y_{FC}) are sent to an input of the first logic unit 521, an input of the second logic unit 522, an input of the third logic unit 523 and an input of the fourth logic unit 524. Each logic unit 521, 522, 523, 524 connects its input to one of its outputs as a function of the processing unit UT concerned. Thus the register blocks 531, 532, 533 and 534 contain the coordinates x_{FA}, y_{FA}, X_{FC} and y_{FC} respectively, for all the processing units UT used.

FIG. 7 shows an exemplary embodiment of a descriptor loop unit 6. The unit 6 comprises a first logic unit 61 receiving at its input the data from the first and second register blocks 531 and 532, in other words the coordinates x_{FA} and y_{FA} for the different processing units UT used, together with a second logic unit 62 receiving at its input the data from the third and fourth register blocks 533 and 534, in other words the coordinates x_{FC} and y_{FC}. The unit 6 also comprises a memory 63 containing the relative coordinates (x′_{DA},y′_{DA}) and (x′_{DC},y′_{DC}) of the different descriptors D, these descriptors varying as a function of the current stage. The relative coordinates (x′_{DA},y′_{DA}) and (x′_{DC},y′_{DC}) of the descriptors D forming the classifier associated with the current stage are sent successively to a first input 641 of a calculation unit 64. This calculation unit 64 also receives on a second and a third input 642 and 643 the coordinates (x_{FA},y_{FA}) and (x_{FC},y_{FC}) of the detection windows F, via the outputs of the logic units 61 and 62. The calculation unit 64 can thus calculate the absolute coordinates (x_{DA},y_{DA}) and (x_{DC},y_{DC}) of the corners D_{A} and D_{C} of the descriptors D. The absolute coordinates (x_{DA},y_{DA}) and (x_{DC},y_{DC}) are then sent to a register block 65 via a logic unit 66 which includes, for example, an input and four outputs, each output being connected to one of the four data registers of the register block 65. The descriptor loop unit 6 also includes a finite state machine 67 which controls the logic units 61, 62 and 66 and the read access of control means 671, 672, 673 and 674 to the memory 63. The finite state machine 67 receives the iteration numbers in the scale loop and in the stage loop through the connecting means 675 and 676, in order to generate successively the descriptors D for each detection window F allocated to a processing unit UT. The unit 6 can also include a calculation unit 68 which calculates the surface of the descriptors from absolute coordinates (x_{DA},y_{DA}) and (x_{DC},y_{DC}). The value of this surface can be stored in a data register 69.

FIG. 8 shows an exemplary embodiment of a histogram determination unit 7. The unit 7 is divided into three parts. A first part 71 generates the memory addresses of the pixels D_{A}, D_{B}, D_{C} and D_{D} corresponding to the four corners of the descriptors D from the absolute coordinates (x_{DA},y_{DA}) and (x_{DC},y_{DC}) of the corners D_{A} and D_{C}. A second part 72 calculates the components Cₘ of histograms by the method of Viola and Jones, and a third part 73 filters the histogram components Cₘ. The first part 71 comprises an address generator 711 receiving at its input the absolute coordinates (x_{DA},y_{DA}) and (x_{DC},y_{DC}) and the surface of the descriptor D in question. The surface of the descriptor D can thus be transmitted to the processing units UT through the histogram determination unit 7 at the same time as the histogram components Cₘ. Starting from the absolute coordinates (x_{DA},y_{DA}) and (x_{DC},y_{DC}), the address generator 711 finds the absolute coordinates (x_{DB},y_{DB}) and (x_{DD},y_{DD}) of the other two corners D_{B} and D_{D} of the descriptor D, in other words (x_{DC},y_{DA}) and (x_{DA},y_{DC}) respectively. Thus the address generator 711 generates the memory addresses of the four corners D_{A}, D_{B}, D_{C} and D_{D} of the descriptor D for each integral image I_{int,m}. The weights wo(x_{DA},y_{DA}), wo(x_{DB},y_{DB}), wo(x_{DC},y_{DC}) and wo(x_{DD},y_{DD}) of these pixels D_{A}, D_{B}, D_{C} and D_{D} are loaded from the memory 2 to a register block 712 including 4×(M+1) data registers, for example through a logic unit 713. The second part 72 comprises a set 721 of adders and subtracters whose input is connected to the register block 712 and whose output is connected to a register block 722 including M+1 data registers. This second part 72, and in particular the set 721 of adders and subtracters, is designed to generate M+1 histogram components Cₘ in each clock cycle. Each component Cₘ is calculated from the weights wo(x_{DA},y_{DA}), wo(x_{DB},y_{DB}), wo(x_{DC},y_{DC}) and wo(x_{DD},y_{DD}) of the pixels D_{A}, D_{B}, D_{C} and D_{D} of an integral image I_{int,m} and stored in one of the data registers of the register block 722. For an integral image I_{int,m} and a descriptor D as shown in FIG. 5, the calculation of the component Cₘ, where m is an integer in the range from 1 to M+1, can be modeled by the following relation:

Cₘ=D_{C}−D_{B}−D_{D}+D_{A} (2)

Thus each component Cₘ contains the sum of the weights wo(x,y) of the pixels p(x,y) of an orientation image Iₘ contained in the descriptor D. The third part 73 comprises a filter 731 which eliminates the histograms having a very small luminous intensity gradient, because these are considered to be noise. In other words, if the component C_{M+1} is below a predetermined threshold, called the histogram threshold Sₕ, all the components Cₘ are set to zero. The components Cₘ are then stored in a register block 732 so that they can be used by the processing units UT.

The histogram determination unit 7 is an important element of the device 1. Its performance is directly related to the bandwidth of the memory 2. In order to calculate a histogram, access to 4×(M+1) data is required. If the memory 2 can access k data per cycle, a histogram is calculated in a number of cycles N_{c} defined by the relation:

$${N}_{c} = 4 \times \frac{( M + 1 )}{k} \qquad ( 3 )$$

Advantageously, the memory 2 has a large bandwidth to enable the factor k to be close to 4×(M+1). In any case, the factor k is preferably chosen in such a way that the number of cycles N_{c} is less than ten. This number N_{c} corresponds to the calculation time of a histogram. This time can be masked in the analysis of a histogram by the buffer memory 27 of the processing units UT.

FIG. 9 shows an exemplary embodiment of a score analysis unit 8. The unit 8 comprises a FIFO stack 81, in other words a stack whose first input data element is the first output. The FIFO stack 81 can be used to control the list of positions. In particular, it can store the coordinates (x_{FA},y_{FA}) and (x_{FC},y_{FC}) of the detection windows F for which the global score S of the classifier is greater than the current stage threshold Sₑ, this threshold Sₑ being variable as a function of the stage. The FIFO stack 81 can also store the global scores S associated with these coordinates (x_{FA},y_{FA}) and (x_{FC},y_{FC}). Since the current iteration of the scale loop is known, only the coordinates (x_{FA},y_{FA}) of the detection windows F can be stored in order to determine the position and size of the detection windows F. In one specific embodiment, shown in FIG. 9, the FIFO stack 81 successively receives the coordinates x_{FA} of the register block 531 through a logic unit 82, and the coordinates y_{FA} of the register block 532 through a logic unit 83. The global scores S calculated by the N processing units UT are stored in a register block 84 and are sent together with the coordinates x_{FA} and y_{FA} to the FIFO stack 81 through a logic unit 85. Depending on the global score S associated with a detection window F, the coordinates (x_{FA},y_{FA}) may or may not be written to the FIFO stack 81. The score S is, for example, compared with the current stage threshold Sₑ. The different stage thresholds Sₑ can be stored in a register block 86. The stage threshold Sₑ is selected, for example, by a logic unit 87 whose inputs are connected to the register block 86 and whose output is connected to a comparator 88. The comparator 88 compares each of the scores S with the current stage threshold Sₑ. If the score S is greater than the threshold Sₑ, the coordinates (x_{FA},y_{FA}) are written to the FIFO stack 81. The logic units 82, 83, 85 and 87 can be controlled by a finite state machine 89. The unit 8 can also include an address generator 801 controlling the reading from the FIFO stack 81 and the export of its data to the cascade unit 5 to enable the detection windows F which have passed the current stage to be analyzed in the next stage. At the end of each iteration of the scale loop, the FIFO stack contains the list of positions which have successfully passed all the stages, in other words the positions containing the object to be recognized. The content of the FIFO stack 81 can thus be transferred to the memory 2 by means of the memory controller 3.

In a specific embodiment, the device 1 comprises a parameter extraction unit 10 as shown in FIG. 1. The unit 10 comprises a memory in which the parameters attribute, descriptor threshold S_{d}, α and β are stored for each stage. These parameters are determined in a training step carried out before the use of the device 1. On each iteration of the stage loop in the steps E₄₂ and E₅₄, the corresponding parameters are sent to the processing units UT that are used.

In a specific embodiment, the device 1 comprises an image divider unit 11 as shown in FIG. 1. This unit 11 can be used to divide images, in this case the M+1 integral images, into a number of sub-images. It is particularly useful if the images to be analyzed have a resolution such that they occupy a memory space in excess of the capacity of the memory 2. In this case, the sub-images corresponding to a given region of the integral images are loaded successively into the memory 2. The device 1 can then process the sub-images in the same way as the integral images by repeating the step E₄ as many times as there are sub-images, the image analysis being terminated when all the sub-images have been analyzed. The image divider unit 11 comprises a finite state machine generating the boundaries of the sub-images as a function of the resolution of the images and the capacity of the memory 2. The boundaries of the sub-images are sent to the cascade unit 5 in order to adapt the size and movement step of the detection windows to the sub-images.

1. A device for recognizing and locating objects in a digital image by scanning detection windows, the device including a data stream pipeline architecture and comprising:
means for generating a descriptor for each detection window, each descriptor delimiting part of the digital image belonging to the detection window concerned,
a histogram determination unit which determines, for each descriptor, a histogram representing features of the part of the digital image delimited by the descriptor concerned,
N parallel processing units, a detection window being allocated to each processing unit, each processing unit being capable of analyzing the histogram of the descriptor concerned as a function of parameters associated with each descriptor, to provide a partial score representing the probability that the descriptor contains at least a part of the object to be recognized, the sum of the partial scores of each detection window providing a global score representing the probability that the detection window contains the object to be recognized.

2. The device according to claim 1, characterized in that it is implemented in a special-purpose integrated circuit such as an Application Specific Integrated Circuit (ASIC).

3. The device according to claim 1, wherein the means for generating a descriptor for each detection window, the histogram determination unit and the set of the N processing units each form a stage of the pipeline architecture.

4. The device according to claim 1, wherein the digital image is converted into M+1 orientation images, each of the first M orientation images containing, for each pixel, the gradient of the amplitude of a signal over a range of angle values, the final orientation image containing, for each pixel, the magnitude of the gradient of the amplitude of the signal, each histogram including M+1 components, each component containing the sum of the weights of the pixels of one of the orientation images contained in the descriptor in question.

5. The device according to claim 4, wherein each processing unit comprises:
a first logic unit comprising M+1 inputs and an output, for the successive selection of one of the components of a histogram as a function of the first parameter,
a comparator which compares the selected component with the second parameter,
a second logic unit comprising two inputs and an output, the first input receiving the third parameter, the second input receiving the fourth parameter and the output delivering either the third parameter or the fourth parameter as a function of the result of the comparison,
an accumulator connected to the output of the second logic unit, which adds together the third and/or fourth parameters in order to provide, on the one hand, the partial scores associated with the different descriptors (D) of the detection window concerned, and, on the other hand, the global score associated with the detection window.

6. The device according to claim 5, wherein each processing unit comprises a third logic unit and a multiplier, the logic unit receiving the M+1th component of the histogram concerned on a first input and a surface of the descriptor concerned on a second input and connecting to a first input of the multiplier either the first input of the logic unit, when one of the first M components is compared with the second parameter, or the second input of the logic unit, when the M+1th component is compared with the second parameter, a second input of the multiplier receiving the second parameter, an output of the multiplier being connected to an input of the comparator in such a way that the selected component is compared with the second parameter weighted either by the M+1th component or by the surface of the descriptor.

7. The device according to claim 4, wherein the histogram determination unit can determine a histogram from M+1 integral images, each integral image being an image where the weight of each pixel is equal to the sum of the weights of all the pixels of one of the orientation images located in the rectangular surface delimited by the origin and the pixel concerned.

8. The device according to claim 7, further comprising:
a memory containing the M+1 integral images and
a memory controller controlling access to the memory, a bandwidth of the memory being determined in such a way that each histogram is determined from 4×(M+1) data in a number of cycles N_{c} smaller than or equal to ten, the number N_{c} being defined by the relation:
$${N}_{c} = 4 \times \frac{M + 1}{k} ,$$
where k is the number of data which can be accessed by the memory in one cycle.

9. The device according to claim 1, wherein the means for generating a descriptor for each detection window comprise a scale loop unit for iteratively determining a size of the detection windows and a step of movement of these windows in the digital image.

10. The device according to claim 1, wherein the means for generating a descriptor for each detection window comprise a cascade unit for generating coordinates and of detection windows as a function of a size of these windows and of a movement step, and for allocating each detection window to a processing unit.

11. The device according to claim 10, wherein the means for generating a descriptor for each detection window comprise a descriptor loop unit for iteratively generating, for each detection window, coordinates of descriptors as a function of the coordinates of these detection windows and of the object to be recognized.

12. The device according to claim 1, further comprising:
a score analysis unit generating a list of global scores and of positions of detection windows as a function of a stage threshold.

13. The device according to claim 1, further comprising:
a parameter extraction unit for sending the parameters to the N processing units simultaneously.

14. The device according to claim 1, wherein the parameters are determined in a training step, the training depending on the object to be recognized.

15. The device according to claim 1, wherein all the arithmetic operations for implementing the recognition and location of an object are executed using fixed point data in addition, subtraction and multiplication operation devices of the integer type.
